(19) United States
(12) Patent Application Publication
(10) Pub. No.: US 2025/0338872 A1
(43) Pub. Date: Nov. 6, 2025

(54) PLANT PROTEIN COMBINATIONS AND USES THEREOF

(71) Applicants: Redefine Meat Ltd., Rehovot (IL); Tel-Hai College, Upper Galilee (IL)

(72) Inventors: Darya ISRAELI, Kibbutz Hagoshrim (IL); Gili ABRAMOV, Rehovot (IL); Ofir BENJAMIN, Kibbutz Snir (IL); Yael PRIGAT GOLDFRIEND, Tel Aviv (IL)

(21) Appl. No.: 19/192,632

(22) Filed: Apr. 29, 2025

Related U.S. Application Data
(60) Provisional application No. 63/641,657, filed on May 2, 2024.

(51) Int. Cl. A23J 3/14; A23J 3/22; A23L 11/00; A23L 19/12

(52) U.S. Cl. CPC A23J 3/14; A23J 3/227; A23L 11/00; A23L 19/12

(57) ABSTRACT

A gel forming combination, and textured vegetable protein blended therewith, the gel forming combination comprising a first and second plant proteins; wherein, the first plant protein comprises at least one protein or is a protein selected from the group consisting of potato protein and patatin and combination of same; wherein said second plant protein comprises one or more proteins other than potato protein or patatin; and wherein a combination gel, thermally produced from said first plant protein, second plant protein and water; has a hardness that is statistically significantly greater than a hardness of a single protein gel, formed from a single protein of said first plant protein or of said second plant protein, the amount of said single protein in the single protein gel being identical to total proteins amount in said combination gel. Also provided are alternative meat products comprising a gel from the disclosed gel forming combination.

### TECHNOLOGICAL FIELD

The present disclosure relates to the food industry and specifically to plant protein combinations utilization in the food industry.

### BACKGROUND

The increasing awareness to the environmental challenges imposed by animal farming in general and livestock farming specifically drives major efforts towards the development of animal-free alternatives. Today livestock meat plays a key role in human nutrition, delivering protein-rich foods that have being essential part of culinary traditions. The replacement or supplementing of such foods with plant-based analogs is expected to bring multiple health and environmental benefits, yet it imposes a challenging set of criteria that should be met to meet the consumers expectations.

In the last decades the need for plant-based meat has driven the formation of a whole new sector within the food technology domain and is constantly and reliably delivering modules that allow better mimicking of livestock meat characteristics via animal-free pathways. One of the characteristics that still suffer from insufficient imitation is the cooking behavior of meat. Livestock meat behaves like a soft gel in its raw form and turns into hard and texturized gel during the cooking process and specifically upon heating. This process is driven mainly by the denaturation and physical cross-linking of the meat's proteins. Unfortunately, naturally occurring plant proteins rarely display such behavior and form only weak gels, while sometimes requiring higher temperatures and/or longer cooking and is not compatible with routine culinary practice. For this reason, the plant-based meat industry is utilizing methylcellulose (MC) as a key component providing these products with binding and gelation characteristics. MC possess reverse-thermal-gelation (RTG) behavior, namely it hardens upon heating, going from viscous liquid or paste to hard gel. This transition occurs at fast rate and in the range of temperatures that is relevant to livestock meat and to common meat cooking processes, such as pan searing. This makes MC a natural choice for most beef meat analogs, such as burgers, mince meat and steaks. However, MC suffers of several disadvantages, such as its chemical nature, reversible behavior and lack of nutritional contribution, that are driving the research towards protein-based solutions.

### GENERAL DESCRIPTION

The current invention addresses the need for plant-protein-based gelation systems that provide hard gels, suitable for use in the alternative meat industry, and provides combinations of proteins that exhibit synergistic-like behavior once combined according to principles presented below.

Thus, in accordance with a first of its aspects, the present disclosure provides a gel forming combination comprising a first plant protein and a second plant protein;
wherein, the first plant protein comprises at least one protein or is a protein selected from the group consisting of potato protein and patatin and combination of same;
wherein said second plant protein comprises one or more proteins other than potato protein or patatin; and
wherein a combination gel, thermally produced from said first plant protein, second plant protein and water; has a hardness that is statistically significantly greater than a hardness of a single protein gel, formed from a single protein of said first plant protein or of said second plant protein, the amount of said single protein in the single protein gel being identical to total proteins amount in said combination gel.

In accordance with a second of its aspects, the present disclosure provides a modified texturized vegetable protein (TVP) comprising TVP blended with a gel forming combination comprising a first plant protein and a second plant protein,
wherein, the first plant protein comprises or is selected from the group consisting of potato protein and patatin and combination of same;
wherein said second plant protein comprises one or more proteins other than potato protein or patatin; and
wherein a combination gel, thermally produced from the modified TVP and water, has a hardness that is statistically significantly greater than a hardness of (i) TVP gel formed from a same amount of TVP without said gel forming combination; and/or (ii) TVP gel formed from a same amount of TVP and a single plant protein out of the first plant protein or second plant protein, the amount of the single plant protein being identical to the total amount of proteins in the gel forming combination.

In accordance with a third of its aspects, the present disclosure provides a combination gel comprising the presently disclosed gel forming combination, according to the presently disclosed first aspect, and water, wherein the protein content in the combination gel is at least 12 wt %.

In accordance with a fourth of its aspects, the present disclosure provides a modified TVP gel comprising the modified TVP according to the presently disclosed second aspect, and water, the amount of water constituting at least 70% out of a total weight of said gel.

Finally, in accordance with a presently disclosed fifth aspect, there is provides an alternative meat product comprising a gel comprising a gel forming combination according to the presently disclosed first aspect, or a modified TVP according to the presently disclosed second aspect, or a combination gel according to the presently disclosed third aspect, or a modified TVP gel according to the presently disclosed fourth aspect.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1C are bar graphs providing texture profile analysis (TPA) results of different combinations of potato protein with canola protein at a total protein content of 17 w % (FIG. 1A), 14 w % (FIG. 1B) or 12 w % (FIG. 1C).

FIG. 2 is a bar graph providing TPA results of different combinations of potato protein with chickpea protein at a total protein content of 17 w %.

FIG. 3 is a bar graph providing TPA results of different combinations of potato protein with canola protein, and canola oil, resulting in an emulsion.

FIGS. 4A-4C is a bar graph providing TPA results of different protein combinations with TVP, including a 3:5 Protein to TVP ratio (FIG. 4A), 1:1 Protein to TVP ratio (FIG. 4B), or 5:2 Protein to TVP ratio (FIG. 4C).

### DETAILED DESCRIPTION

A successful utilization of plant proteins in meat analogues largely relies on the ability to transform proteins into functional ingredients that give meat its texture, structure, and stability during cooking. While livestock (animal) meat proteins have unique native structure and gelation properties, plant-based proteins require processing and modifications to form gels with similar characteristics. It has been envisaged that improving the meaty texture of plant proteins can be achieved by improved protein gelation.

Thus, the presently disclosed subject matter, provides, in accordance with a first of its aspects, a gel forming combination comprising a first plant protein and a second plant protein;
wherein, the first plant protein comprises at least one protein or is a protein selected from the group consisting of potato protein and patatin or a combination of potato protein and patatin;
wherein the second plant protein comprises one or more proteins that are not potato protein or patatin; and
wherein a combination gel, thermally produced from a blend of the first plant protein, the second plant protein and water; has a hardness that is statistically significantly greater than a hardness of a single protein gel, formed from a single protein of said first plant protein or of said second plant protein, the amount of said single protein in the single protein gel being identical to total proteins amount in said combination gel.

In the context of the presently disclosed subject matter, the term “gelforming combination” is to be understood to encompass a composition comprising at least two edible/comestible plant proteins, a first plant protein out of the at least two plant proteins being potato protein, patattin or a combination of potato protein and pattatin; and a second plant protein out of the at least two plant proteins being a plant protein that is different from potato protein and from patattin, as further elaborated hereinbelow.

In the context of the presently disclosed subject matter, the term “gelforming combination” is also to be understood to encompass a composition of the at least two edible plant proteins, which, upon mixing with/dissolving in an aqueous medium, e.g. water, transformed from a liquid state into a gel state.

In some examples of the presently disclosed subject matter, the transformation from a liquid state to a gel state involves subjecting the aqueous medium with the combination to conditions that promote the formation of the gel, such conditions include, for example, temperature (heating or cooling), pH, the presence of specific chemicals or enzyme. In some particular examples, the condition comprises at least heating the mixture of the combination with aqueous medium, as further described below.

The gel forming combination comprises a first plant protein and a second plant protein.

In some examples of the presently disclosed subject matter, the first plant protein comprises or consists of potato protein.

In some examples of the presently disclosed subject matter, the first plant protein comprises or consists of patatin.

In some examples of the presently disclosed subject matter, the first plant protein comprises or consists of potato protein and patatin.

In some examples of the presently disclosed subject matter, the second plant protein is a plant protein excluding potato protein and excluding patatin. In the context of the presently disclosed subject matter, when referring to a plant protein “other than” or “different from” the first plant protein it is to be understood to encompass any edible plant protein, preferably one or more of those edible proteins suitable for use or known to be used or acceptable for use in the food and beverages industry, for the production of comestible products.

In some examples of the presently disclosed subject matter, the second plant protein is any food safe, and preferably edible protein derived from plant material. The plant material can be any one of cereals, legumes, oil seeds, nuts, pseudocereals, tubers, fruits and vegetables. Additionally, as used herein, the second plant protein may include fungal protein originating from fungal growth in or on a plant-based substrate.

In some examples of the presently disclosed subject matter, the second plant protein comprises or is a protein is derived from a plant based material including cereals such as wheat, corn, oat, rice and barley; legumes such as soy, peas, beans, chickpea, lentils, lupins, and faba beans; oil seeds such as sunflower, rapeseed, flaxseed, hemp seed, cotton seed, sesame seed, and pumpkin seed; nuts such as almond, pistachio, cashew, walnut and peanut; pseudocereals such as quinoa, buckwheat, chia seed and amaranth; fruits; vegetables, and any mixtures thereof.

In some examples of the presently disclosed subject matter, the second plant protein comprises or is a protein selected from pea protein, soy protein, hemp protein, almond protein, cashew protein, canola (rapeseed) protein, chickpea protein, wheat protein, lupine, rice protein, fava bean protein, mung bean protein, sunflower seed protein, red lentil protein, oat protein, lentils, quinoa protein, seaweed protein, spinach protein, broccoli protein,

In some examples of the presently disclosed subject matter, the second plant protein is selected from the group consisting of chickpea protein and canola protein.

In some examples of the presently disclosed subject matter, the second plant protein is or consists essentially of chickpea protein.

In some examples of the presently disclosed subject matter, the second plant protein is or consists essentially canola protein.

Notwithstanding the possible proteins that would constitute the second plant protein, it is noted that neither the first not the second plant protein can comprise or be soy protein.

In some examples of the presently disclosed subject matter, the gel forming combination comprises potato protein (as the first protein) and canola protein (as the second protein).

In some examples of the presently disclosed subject matter, the gel forming combination comprises proteins, the proteins consisting of potato protein (as the first protein) and canola protein (as the second protein).

In some examples of the presently disclosed subject matter, the gel forming combination comprises potato protein (as the first protein) and chickpea protein (as the second protein).

In some examples of the presently disclosed subject matter, the gel forming combination comprises proteins, the proteins consisting of potato protein (as the first protein) and chickpea protein (as the second protein).

In some examples of the presently disclosed subject matter, the gel forming combination comprises more than two edible plant proteins.

The plant protein, be it part of the first plant protein or part of the second plant protein, can be in a form of the plant extract, plant concentrate, or plant isolate. accordingly, the gel forming combination can comprise, independently, an extract, a concentrate or an isolate of the first protein and/or the second protein.

The amount of the proteins in the gel forming combination should be sufficient to result in the formation of a gel with a hardness that is greater than the hardness of a gel formed from each protein of the combination.

In some examples of the presently disclosed subject matter, the gel forming combination is characterized by the weight ratio between the protein or proteins constituting the first plant protein and at least one protein constituting the second plant protein. Thus, when referring to a weight ratio between the first plant protein and the second plant protein it is to be understood to encompass any one of (i) a ratio between a single protein of the first single plant protein and a single plant protein of the second plant protein; (ii) a ratio between a single plant protein of the first plant protein and two or more plant proteins constituting the second plant protein (which that are different from potato protein and patatin); (iii) a ratio between the total weight of potato protein and patatin (constituting the first plant protein), and two or more plant proteins that are different from potato protein and patatin and constituting the second plant protein.

In some examples of the presently disclosed subject matter, the gel forming combination comprises a weight ratio between the first protein and the second protein of at least 1:1; at times, of at least 2:1; at times, of at least 3:1; at times, of at least 4:1; at times, of at least 5:1; at times, of at least 6:1; at times, of at least 7:1; at times, of at least 8:1; at times, of at least 9:1; at times, of at least 10:1.

In some examples of the presently disclosed subject matter, the gel forming combination comprises a weight ratio between the first protein and the second protein of between about 1:1 and 10:1, or any range within this range.

The gel forming combination is suitable for forming a gel (referred to herein as the “combination gel”). By the term “suitable” it is to be understood to mean that under conditions that comprise at least mixing with water, a gel is formed.

In some examples of the presently disclosed subject matter, the conditions comprise at least heating of the mixture of the gel forming combination and aqueous medium (e.g. water) to a temperature of at least 70° C., or to a temperature of at least 80° C.; or at least 90° C., as further defined below.

In some examples of the presently disclosed subject matter, the gel forming combination is suitable for forming a combination gel with a total protein content of up to 30 wt %.

In some examples of the presently disclosed subject matter, the gel forming combination is suitable for forming a combination gel with a total proteins content of up to 28 wt %; at times, up to 26 wt %; at times, up to 24 wt %; at times, up to 22 wt %; at times, up to 20 wt %.

In some examples of the presently disclosed subject matter, the gel forming combination is suitable for forming a combination gel with a total proteins content of between 12 wt % and 30 wt % or any range between 12 wt % and 30 wt %, such as, 12-18 wt %, 14-22 wt %, 16-24 wt %, 18-26 wt %, 20-28 wt %, and 12-25 wt %.

The remainder of material in the combination gel comprises at least water, and may include, in addition to the water, lipids (oils), salts, flavoring agents, colorants, preservation agents, texturizing agents, fibers etc., as acceptable in the food industry.

In some examples of the presently disclosed subject matter, the gel forming combination is suitable for forming a gel upon mixing with an amount of water constituting at least 70% of the total weight of the resulting gel; at times, at least 80% of the weight of the gel.

The gel that can be formed from the gel forming combination has a hardness that can be determined by any means known in the art. In some examples of the presently disclosed subject matter, the gel hardness is determined or determinable in a TPA test involved in compressing a 1.5 cm³ (cubic) sample of the resulting gel to 50% of its volume, in a two-cycle texture profile analysis test, using a flat compression probe, a trigger force of 0.1 g (the force required to start the compression), a test speed of 60 mm/min (the speed at which the compression is applied) and a retention time of 1 second (the time the sample is held at the compressed state before release). Notably, in the following non-limiting examples, the hardness value presented relates to the value obtained in the first cycle of the TPA test.

In accordance with the presently disclosed subject matter, the gel formed with the gel forming combination has a hardness that is statistically significantly greater than the hardness of a reference gel, the reference gel being either a gel formed from a single protein of the first plant protein or of the second plant protein, or if the gel comprises TVP, as discussed below, the reference gel is one comprising the TVP and a single protein of the first plant protein or of the second plant protein. It is to be appreciated that the term “statistically significantly greater” as used herein, denotes a difference that is considered significant by commonly used statistical tests, such as Student's test, with typical p-value for determining statistical significance being less than 0.05 (p<0.05).

The present disclosure also provides, in accordance with a second of its aspects, a textured vegetable protein that is modified with the gel forming combination according to the presently disclosed first aspect.

Specifically, there is also provided a modified texturized vegetable protein (TVP).

In the context of the presently disclosed subject matter, the term “modified TVP” encompasses TVP, as known in the art, that is combined/blended with the presently disclosed gel forming combination.

Thus, the disclosed modified TVP comprises TVP blended with the presently disclosed gel forming combination, the gel forming combination comprises, as defined and described hereinabove, a first plant protein and a second plant protein, the first plant protein comprises or is selected from the group consisting of potato protein and patatin and combination of same and the second plant protein comprises one or more proteins other than potato protein or patatin; wherein a combination gel, thermally produced from the modified TVP and water, has a hardness that is statistically significantly greater than a hardness of (i) TVP gel formed from a same amount of TVP without said gel forming combination; and/or (ii) TVP gel formed from a same amount of TVP and a single plant protein out of the first plant protein or second plant protein, the amount of the single plant protein being identical to the total amount of proteins in the gel forming combination.

The gel forming combination in the modified TVP has the same meaning and definitions as provided in connection with the first aspect of the present disclosure, and therefore, it is to be understood that all definitions provided with respect to the presently disclosed first aspect, also apply to the modified TVP, according to the presently disclosed second aspect.

In the context of the presently disclosed subject matter it is to be understood that the term TVP has the same meaning as known in the art. Generally, TVP is also known as textured soy protein and typically, but not exclusively, comprises defatted soy flour. In the context of the presently disclosed subject matter, TVP is produced from any protein-rich seed meal, including lentils, peas, faba beans, cottonseeds, wheat, oats by any way of extrusion, spinning, shear cell technology, chemical texturization, stream injection (or steam cooking) and combinations of same, all as known in the art.

In some examples of the presently disclosed subject matter, the amount of the gel forming combination vs. the amount of the TVP can be defined by the dry weight ratio between the first plant protein, i.e. between at least potato protein, patatin or the potato protein and patatin and the amount of TVP. In some examples of the presently disclosed subject matter, the modified TVP is characterized by a dry weight ratio between the first plant protein and TVP of about 5:2 and about 3:5.

In accordance with yet a third aspect, the present disclosure also provides a gel, referred to herein as a combination gel or modified TVP gel, the gel comprises at least the gel forming combination of the first aspect of the presently disclosed subject matter. Accordingly, all definitions provided with respect to the gel forming combination, also apply to the presently disclosed gel.

In some examples, the gel is a combination gel comprising the gel forming combination disclosed herein and at least 55% water.

In some examples, the gel is a combination gel comprising the gel forming combination disclosed herein and at lest 60% water, at times, at least 65%, at times, at least 70%, at times, at least 75%, at times, 80%; at times, 85% or even 90% water.

In some examples of the presently disclosed subject matter, the combination gel comprises a total protein content of up to 30 wt %.

In some examples of the presently disclosed subject matter, the combination gel comprises a total proteins content of up to 28 wt %; at times, up to 26 wt %; at times, up to 24 wt %; at times, up to 22 wt %; at times, up to 20 wt %.

In some examples of the presently disclosed subject matter, the combination gel comprises a total proteins content of between 12 wt % and 30 wt % or any range between 12 wt % and 30 wt %, such as, 12-18 wt %, 14-22 wt %, 16-24 wt %, 18-26 wt %, 20-28 wt %, and 12-25 wt %.

In some examples of the presently disclosed subject matter, the combination gel comprises in addition to the proteins and water, one or more edible oils.

In some examples, the one or more edible oils is selected from the group consisting of canola oil soybean oil, sunflower oil, safflower oil, corn oil, cottonseed oil, coconut oil, palm oil, cocoa butter oil and any combination of same.

The presently disclosed combination gel can be characterized by its hardness, the hardness being determined or determinable as described hereinabove.

In some examples of the presently disclosed subject matter, the combination gel has a hardness that is statistically significantly greater that the hardness of a single protein gel obtained from a single protein that is one of the proteins constituting the first protein of the combination gel, or a single protein of the second protein and under a same process or obtaining the combination gel, the amount of the single protein being identical to the total amount of proteins in the combination gel.

For the sake of clarity, for example, if the combination gel is formed from a protein mixture comprising 12 wt % potato protein (the first plant protein) and 3 wt % of the second plant protein (e.g. canola protein), the hardness of the combination gel is statistically significantly greater than the hardness of a gel formed, by the same process, from 15 wt % potato protein and/or from 15 wt % canola protein.

In some examples, the gel is a modified TVP gel comprising TVP blended with the gel forming combination disclosed herein and at least 70% water.

In some examples, the gel is a modified TVP gel comprising TVP blended with the gel forming combination disclosed herein and at least 75%, at times, 80%; at times, 85% or even 90% water.

The remainder of material in the modified TVP gel comprises at least water, and may include, in addition to the water, lipids (oils), salts, flavoring agent, colorants, preservation agents, texturizing agents, fibers etc., as acceptable in the food industry.

In some examples of the presently disclosed subject matter, the modified TVP gel comprises in addition to the proteins and water, one or more edible oils.

In some examples, the one or more edible oils is selected from the group consisting of canola oil, soybean oil, sunflower oil, safflower oil, corn oil, cottonseed oil, coconut oil, palm oil, cocoa butter oil and any combination of same.

The presently disclosed modified TVP gel can be characterized by its hardness, the hardness being determined or determinable as described hereinabove.

In some examples of the presently disclosed subject matter, the modified TVP gel has a hardness that is statistically significantly greater that the hardness of a gel formed only from TVP or a gel formed from TVP and a single protein that is one of the proteins constituting the first protein of the gel forming combination, or a single protein of the second protein of the gel forming combination and under a same process for obtaining the modified TVP gel, the amount of the single protein being identical to the total amount of proteins in the gel forming combination in the modified TVP.

Thus, for the sake of illustration, for a modified TVP gel comprising TVP and an amount of gel forming combination of 15%, including 12 wt % potato protein and 3 wt % canola protein, the modified TVP gel has a hardness that is statistically significantly greater than the hardness of a gel formed from a same amount of TVP and either 12 wt % potato protein or 3 wt % canola protein.

The gel forming combination can be used as part of an alternative food product, preferably alternative meat product. To this end, the present disclosure also provides, in accordance with a fourth of its aspects, a method of producing an alternative meat product, the method comprises mixing a solution comprising a gel forming combination with at least one alternative meat ingredient and causing gelation.

In the context of the presently disclosed subject matter, the alternative meat ingredient is to be understood to encompass any ingredient that would be suitable or is typically used in the alternative food industry, in general, and in the alternative meat industry, specifically.

Finally, the present disclosure provides, in accordance with yet its fifth aspect, an alternative meat product comprising a gel comprising a gel forming combination as disclosed herein and at least one alternative meat ingredient.

In some examples of the presently disclosed fifth aspect, namely, the presently disclosed alternative meat product, the gel comprises, in addition to the gel forming combination also TVP.

The presently disclosed gel forming combination (or modified TVP comprising the same) can be used for a variety of alternative meat products.

In some examples, the alternative meat product according to the presently disclosed fifth aspect is alternative red meat.

In some examples, the alternative meat product according to the presently disclosed fifth aspect is alternative poultry meat.

In some examples, the alternative meat product according to the presently disclosed fifth aspect is alternative fish.

### DESCRIPTION OF NON-LIMITING EXAMPLES

### Example 1: Preparation and Characterization of Protein Combinations

### Materials

Chickpea protein isolate (G910) was purchased from ChickP, Rehovot, Israel.

Potato protein isolate (Solanic 200) was purchased from AVEBE, Veendam, Netherlands.

Canola protein isolate (Puratein G) was purchased from Merit functional foods, Winnipeg, Canada.

Canola oil was purchased from a local supermarket in Israel.

### Methods

### Emulsion Preparation

For emulsion preparation, the protein solutions were homogenized with Canola oil to create emulsions. The homogenization was done in a homogenizer at 1500 RPM until a smooth homogenic emulsion was formed.

### Gels Preparation:

The following method was applied for any type of protein composition, be it proteins combination solution, proteins combination emulsion or proteins solution mixed with TVP (See Table 1 below).

Specifically, in a chemical beaker containing distilled water, protein powders were gradually added, while mixing with a magnetic stirrer or manually (depending on viscosity of the mixture), for 30 minutes (the time until all powders were added). Where foam was formed during mixing, the foam was removed before thermal gelation.

The beakers were then covered with aluminum foil and were incubated within a water bath at 95° C. for 1 hour for the thermal gelation. After gelation, the samples were cooled to 4° C., overnight, before characterization by TPA test.

### Texture Profile Analysis:

The textural properties of the gel samples were measured with a TA1 texture analyzer (Lloyd Instruments, Fareham, UK).

From each gel formed, 3 cubes of 1.5 cm×1.5 cm×1.5 cm were cut. The cubes were tested at 4° C. Samples were compressed using a simple flat compression probe. The texture profile was obtained in a two-cycle process. The trigger force was 0.1 g. The test speed was 60 mm/min, and the wait time was 1 s. The sample was compressed to 50% of its height. NextGEN Plus data analysis software (Lloyd Instruments, Fvareham, UK) was used to calculate hardness.

### Results

Three proteins combinations were prepared by suspending in water different combinations of potato protein with canola protein, to provide protein combinations as detailed in Table 1.

Table 1 also provide results of hardness test performed using TPA analysis, as described above.

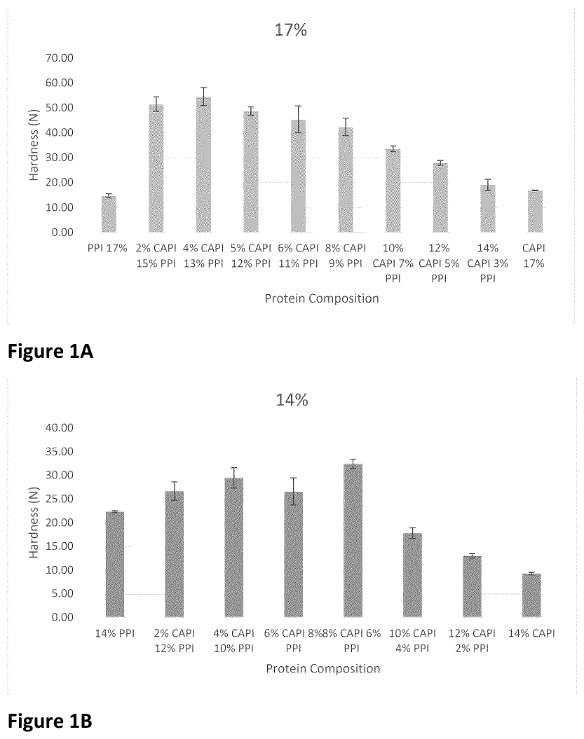

The results presented in Table 1 are, also presented in FIGS. 1A-1C.

TABLE 1
Potato and canola proteins combination

| Total amount | % Potato protein | % Canola protein | Hardness (N) |
|---|---|---|---|
| 17% | 17 | — | 14.67 |
| | 15 | 2 | 51.46 |
| | 13 | 4 | 54.48 |
| | 12 | 5 | 48.64 |
| | 11 | 6 | 45.34 |
| | 9 | 8 | 42.27 |
| | 7 | 10 | 33.50 |
| | 5 | 12 | 27.86 |
| | 3 | 14 | 18.97 |
| | 0 | 17 | 16.84 |
| 14% | 14 | — | 22.34 |
| | 12 | 3 | 26.65 |
| | 10 | 4 | 29.44 |
| | 8 | 6 | 26.58 |
| | 6 | 8 | 32.44 |
| | 4 | 10 | 17.80 |
| | 2 | 12 | 13.00 |
| | — | 14 | 9.22 |
| 12% | 12 | — | 7.07 |
| | 10 | 2 | 11.9 |
| | 8 | 4 | 15.27 |
| | 6 | 6 | 17.00 |
| | 4 | 8 | 13.42 |
| | 2 | 10 | 13.13 |
| | — | 12 | 4.25 |

The results show that each of the tested proteins (i.e. when the solution contained a single protein) resulted in a gel like mixture that has a strength that is statistically significantly lower than the hardness given when the two proteins were combined, at a same total protein amount.

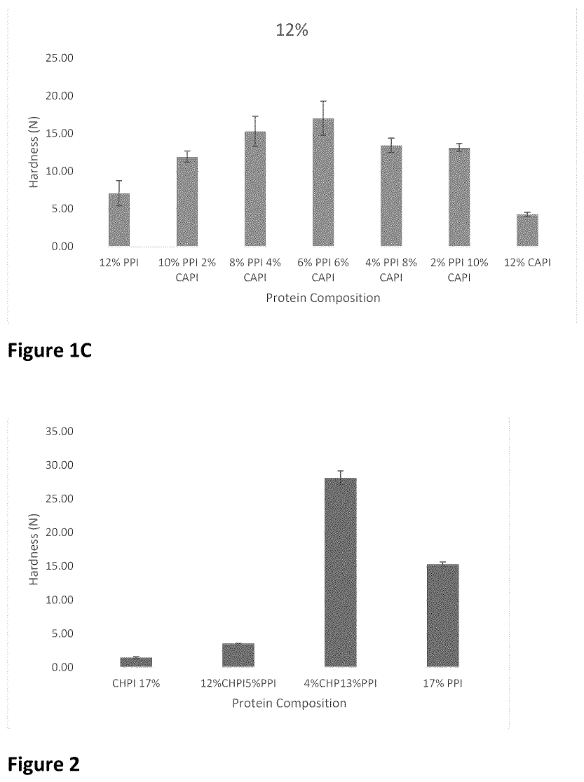

Similarly, the hardness of solutions comprising combinations of potato protein with chickpea protein was measured at the same manner, and the results are summarized in Table 2 and FIG. 2.

TABLE 2
Potato and chickpea proteins combination

| Total amount | % Potato protein | % Chickpea protein | Hardness (N) |
|---|---|---|---|
| 17% | 17 | — | 15.30 |
| | 13 | 4 | 28.12 |
| | 6 | 12 | 3.54 |
| | — | 17 | 1.44 |

The results show that, like the effect exhibited when combining potato protein with canola protein, the tested protein (single protein sample) resulted in a gel like mixture that has a strength that is statistically significantly lower than the hardness given when the two proteins were combined, at a same total protein amount.

Table 2 also suggests the need of a higher potato protein content as compared to the second protein of the combination.

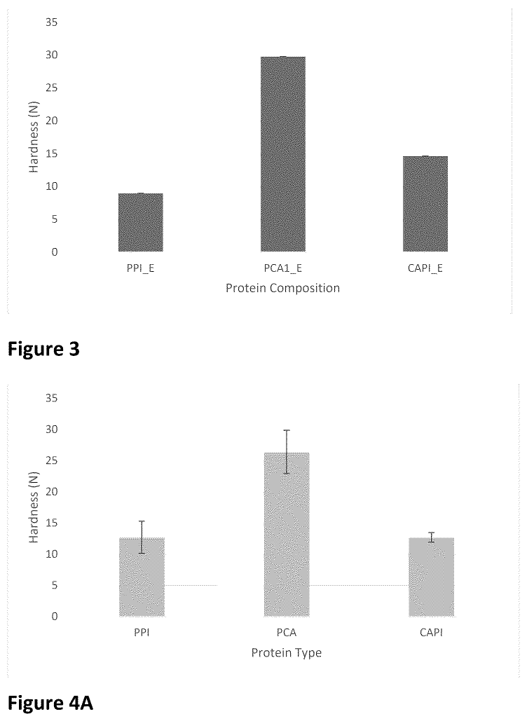

When testing the gel formation of Potato/chickpea proteins combination (total amount of 14%) with canola oil, a similar contributory effect of the combination (over a single protein emulsion) was observed, as summarized in Table 3 and shown in FIG. 3.

TABLE 3
Potato and canola protein emulsions

| Total amount | % Potato protein | % Chickpea protein | Hardness (N) |
|---|---|---|---|
| 14% protein | 14 | — | 8.94 |
| 63% distilled water | 11 | 3 | 29.73 |
| 23% Canola oil | — | 14 | 14.59 |

The results in Table 3 and FIG. 3 further confirm that the formation of an emulsion does not affect the unique increased hardness observed when combining potato protein with a second protein. In other words, even with the presence of oil, a “synergistic-like” relationship between the two proteins is observed. This may also suggest that one may use a protein combination comprising protein concentrates (that may include oil) and that it is not mandatory to use a pure protein or protein isolate, to achieve improvement in rheological properties, such as hardness.

### Example 2: Preparation and Characterization of Modified Textured Vegetable Protein (TVP)

### Materials

TVP comprises soy protein and pea protein were obtained from PURIS (https://www.puris.com/about/)

Potato protein and canola protein are as described in Example 1.

### Methods

### Modified TVP

A modified TVP was prepared by adding proteins combination solutions (prepared as described in Example 1) into soaked or unsoaked TVP. The soaked TVP was prepared by soaking the TVP with distilled water for 30 min at a ratio of 1:2 TVP:water.

The proteins/TVP mixture was then allowed to rest at room temperature (about 25° C.) for 30 min before cooking.

The proteins/TVP mixture was incubated at water bath, set at a temperature of 95° C., for 30 min similarly as described above.

Samples were cooled to 4 C for the night before TPA test.

### Texture Profile Analysis:

The textural properties of the gel samples were measured with a TA1 texture analyzer (Lloyd Instruments, Fareham, UK). From each gel, 3 cubes of 1.5 cm×1.5 cm×1.5 cm were cut. The cubes were tested at 4° C. Samples were compressed using a simple flat compression probe. The texture profile was obtained in a two-cycle process. The trigger force was 0.1 g. The test speed was 60 mm/min, and the wait time was 1 s. The sample was compressed to 50% of its height. NextGEN Plus data analysis software (Lloyd Instruments, Fvareham, UK) was used to calculate hardness.

### Results

Several protein combinations were mixed with TVP (either pre-soaked with water or without pre-soaking) to form “modified-TVP” which were then subject to thermal treatment to form a modified TVP gel.

The aim of this study was to determine, inter alia, whether the “synergistic-like” effect observed with the proteins' combination is exhibited in the presence of TVP, and whether the incorporation of proteins combination can improve the rheological properties of TVP.

The modified TVP were prepared by mixing for 30 minutes the two proteins powders (See Table 4) with water to reach a protein solution comprising the target weight % of the protein (17% protein in solution).

In parallel, TVP was soaked in water at a weight ratio of 1:1, for 30 minutes.

The proteins solution was then mixed with the soaked TVP or with dry TVP and incubated in a water bath set at 95° C. for 30 minutes. After incubation period, the modified TVP mixtures were cooled, overnight, at 4° C.

It is noted that TVP did not hold together without the protein, probably due to is small sized particles that needed the protein to act as a glue.

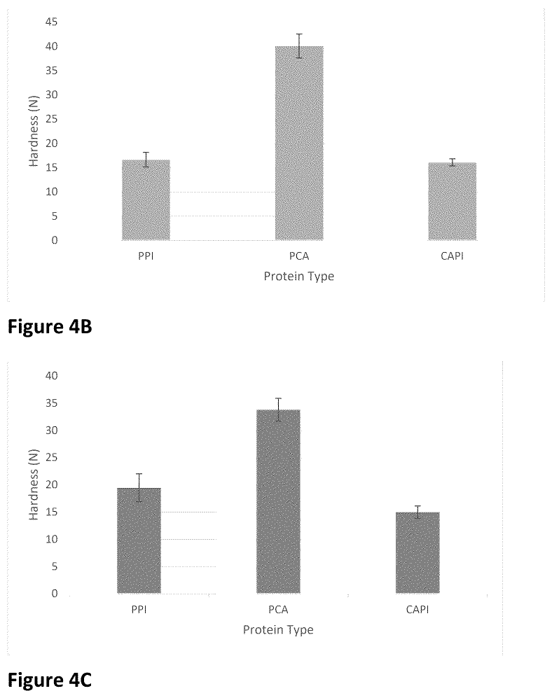

Table 4 provides the different Modified TVP, i.e. the different mixtures of the protein combinations with TVP and the hardness values as tested by TPA analysis. Further, additional (other) results are exhibited in FIGS. 4A-4C.

TABLE 4
Potato and Canola protein solution with TVP

| Proteins:TVP | % TVP | % Potato protein | % Canola protein | Hardness (N) |
|---|---|---|---|---|
| 3:5 | 15.00 | 9.21 | — | 12.68 |
| | | 7.05 | 1.79 | 26.35 |
| | | — | 8.73 | 12.67 |
| 1:1 | 11.09 | 13.68 | — | 16.63 |
| | | 10.46 | 2.96 | 40.07 |
| | | — | 12.69 | 16.06 |
| 5:2 | 6.38 | 15.7 | — | 19.44 |
| | | 12.00 | 3.34 | 33.76 |
| | | — | 14.89 | 14.94 |

% is based on dry weight

Table 4 and FIGS. 4A-4C confirm that a “synergistic-like” effect of the proteins' combination is exhibited also in the presence of TVP and suggests that the incorporation of the modification of TVP with the proteins' combination improves the rheological properties of TVP.

### Example 3: Preparation of Alternative Red Meat Products (Burger and Whole Cut)

For preparing alternative red meat products, the modified TVP of Example 2, before cooking, is mixed with Psyllium husk as a thickening agent beet root extract and browned pear as and flavors to provide three different formulations (RM1, RM2 or RM3), as detailed in the following Table 5.

TABLE 5
Alternative red meat compositions

| | % RM1 | % RM2 | % RM3 |
|---|---|---|---|
| Water | 72.15 | 71.50 | 74.28 |
| TVP | 15.00 | 11.10 | 6.38 |
| Potato protein | 7.05 | 10.45 | 12.00 |
| Canola protein | 1.80 | 2.95 | 3.34 |
| Psyllium husk | 2.00 | 2.00 | 2.00 |
| Colorants | 0.50 | 0.50 | 0.50 |
| Flavors | 1.50 | 1.50 | 1.50 |
| | 100.00 | 100.00 | 100.00 |

The red meat (RM) formulations are then 3D printed into a whole-cut meat-like product, that undergoes a cooking process of incubation in a water bath set at 95° C. for 30 minutes. After incubation period, the 3D printed alternative red meat product is cooled, overnight, at 4° C.

In a further formulation, the modified TVP of Example 2, before cooking, is mixed with Canola oil, Psyllium husk as a thickening agent or gluten as a binding agent, beet root extract and browned pear as colorants and flavors to provide two different formulations, BB1 and BB2, as detailed in the following Table 6.

TABLE 6
Alternative red meat compositions

| | % BB1 | % BB2 |
|---|---|---|
| Water | 55.4 | 56.5 |
| TVP | 23.0 | 18.3 |
| Canola oil | 9.0 | 13.0 |
| Gluten | — | 5.0 |
| Potato protein | 6.0 | 2.5 |
| Canola protein | 2.0 | 1.5 |
| Flavors | 1.5 | 1.5 |
| Psyllium husk | 1.4 | — |
| Potato flakes | 1.0 | 1.1 |
| Colorants | 0.50 | 0.5 |
| Baking Soda | 0.2 | 0.1 |
| Total | 100.0 | 100.0 |

The Burger formulations were molded into a patty and cooked on a pan at 170° C. until an inner temperature of 72° C. was achieved.

Whole cut formulations were also prepared. Specifically, the modified TVP of Example 2, before cooking, is mixed with Canola oil, Psyllium husk as a thickening agent or gluten as a binding agent, beet root extract and browned pear as colorants and flavors to provide two different formulations (HC1 and HC2), as detailed in the following Table 7.

The whole cut formulations were 3D printed into a whole-cut meat-like product, sliced into steak-like products that were cooked on a pan at 170° C. until an inner temperature of 72° C. was achieved.

1. A gel forming combination, comprising:
a first plant protein; and
a second plant protein;
wherein, the first plant protein comprises at least one protein or is a protein selected from the group consisting of potato protein and patatin and combination of same;
wherein said second plant protein comprises one or more proteins other than potato protein or patatin; and
wherein a combination gel, thermally produced from said first plant protein, second plant protein and water; has a hardness that is statistically significantly greater than a hardness of a single protein gel, formed from a single protein of said first plant protein or of said second plant protein, the amount of said single protein in the single protein gel being identical to total proteins amount in said combination gel.

2. The gel forming combination of claim 1, wherein said first plant protein is potato protein.

3. The gel forming combination of claim 1, wherein said second protein is selected from the group consisting of chickpea protein and canola protein.

4. The gel forming combination of claim 1, further comprising any one of extract, concentrate or isolate of said first protein and said second protein.

5. The gel forming combination of claim 1, wherein a weight ratio between said first protein and said second protein is at least 1:1.

6. The gel forming combination of claim 1, wherein a weight ratio between said first protein and said second protein is between 1:1 and 10:1.

7. The gel forming combination of claim 1, wherein said second protein comprises or is chickpea protein and said combination comprises at least 2 w % of said first protein out of a total amount of proteins in said combination.

8. The protein combination of claim 1, wherein said second protein comprises or is canola protein and said combination comprises at least 5 w % of said first protein out of a total amount of protein in said combination.

9. The gel forming combination of claim 1, wherein said hardness is determined by compressing a 1.5 cm³ sample of the gel to 50% of its volume, in a two-cycle texture profile analysis test, using a flat compression probe, a trigger force of 0.1 g, a test speed of 60 mm/min and a retention time of 1 second.

10. The gel forming combination of claim 1, wherein said second protein is not or does not comprise soy protein.

11. A modified texturized vegetable protein (TVP), comprising:
TVP blended with a gel forming combination comprising a first plant protein and a second plant protein,
wherein, the first plant protein comprises or is selected from the group consisting of potato protein and patatin and combination of same;
wherein said second plant protein comprises one or more proteins other than potato protein or patatin; and
wherein a combination gel, thermally produced from the modified TVP and water, has a hardness that is statistically significantly greater than a hardness of (i) TVP gel formed from a same amount of TVP without said gel forming combination; and/or (ii) TVP gel formed from a same amount of TVP and a single plant protein out of the first plant protein or second plant protein, the amount of the single plant protein being identical to the total amount of proteins in the gel forming combination.

12. The modified TVP of claim 11, wherein at least one of the following conditions is fulfilled:
said first plant protein is potato protein;
said second protein is selected from the group consisting of chickpea protein and canola protein;
when said second protein comprises or is chickpea protein, said combination comprises at least 2 w % of said first protein out of a total amount of proteins in said combination; or
when said second protein comprises or is canola protein, said combination comprises at least 5 w % of said first protein out of a total amount of protein in said combination.

13. The modified TVP of claim 11, wherein said gel forming combination at dry weight ratio between the first plant protein said TVP is between about 5:2 and about 3:5.

14. A combination gel, comprising:
a gel forming protein of claim 1; and
water,
wherein the protein content in the combination gel is at least 12 wt %.

15. The combination gel of claim 14, comprising a total protein content of up to 30 wt %.

16. The combination gel of claim 14, wherein at least one of the following conditions is fulfilled:
said second plant protein comprises or is chickpea protein and said first plant protein is in an amount of at least 2 wt % out of a plant protein content in said combination gel; or
said second plant protein comprises or is canola protein and said first plant protein is in an amount of at least 5 wt % out of a plant protein content in said combination gel.

17. The combination gel of claim 14, having a hardness that is statistically significantly greater than the hardness of a single protein gel, formed from a single protein of said first plant protein or of said second plant protein, the amount of said single protein in the single protein gel being identical to total proteins amount in said combination gel.

18. The combination gel of claim 14, comprising one or more edible oils.

19. An alternative meat product, comprising: a gel comprising a gel forming combination of claim 1.

20. The alternative meat of claim 19, being alternative red meat, alternative poultry meat or alternative fish.
